(19) United States
(12) Patent Application Publication
(10) Pub. No.: US 2024/0170682 A1
(43) Pub. Date: May 23, 2024

(54) NEGATIVE ELECTRODE FOR LITHIUM-ION SECONDARY BATTERY, AND LITHIUM-ION SECONDARY BATTERY

(71) Applicant: MURATA MANUFACTURING CO., LTD., Kyoto (JP)

(72) Inventor: Takumi HIASA, Kyoto (JP)

(21) Appl. No.: 18/425,790

(22) Filed: Jan. 29, 2024

Related U.S. Application Data
(63) Continuation of application No. PCT/JP2022/029504, filed on Aug. 1, 2022.

(30) Foreign Application Priority Data
Aug. 2, 2021 (JP) 2021-126557

(51) Int. Cl. H01M 4/80; H01M 4/38; H01M 4/48; H01M 4/62; H01M 10/36

(52) U.S. Cl. CPC H01M 4/803; H01M 4/48; H01M 4/622; H01M 10/36; H01M 4/382; H01M 2300/0002

(57) ABSTRACT

A lithium-ion secondary battery includes a positive electrode, a negative electrode, and an electrolytic solution. The positive electrode allows a lithium ion to be inserted into and extracted from the positive electrode. The negative electrode allows the lithium ion to be inserted into and extracted from the negative electrode, and includes a negative electrode active material layer. The electrolytic solution includes an aqueous solvent. The negative electrode active material layer includes negative electrode active material particles and has a porous structure in which the negative electrode active material particles are directly joined to each other. The negative electrode active material particles each include titanium oxide of an anatase type. An average particle size of the negative electrode active material particles is less than or equal to 100 nm.

### CROSS REFERENCE TO RELATED APPLICATIONS

The present application is a continuation of PCT patent application no. PCT/JP2022/029504, filed on Aug. 1, 2022, which claims priority to Japanese patent application no. 2021-126557, filed on Aug. 2, 2021, the entire contents of which are incorporate herein by reference.

### BACKGROUND

The present application relates to a negative electrode for a lithium-ion secondary battery, and a lithium-ion secondary battery.

Various kinds of electronic equipment, including mobile phones, have been widely used. Such widespread use has promoted development of a lithium-ion secondary battery as a power source that is smaller in size and lighter in weight and allows for a higher energy density. The lithium-ion secondary battery includes a positive electrode, a negative electrode, and an aqueous electrolytic solution. The aqueous electrolytic solution is an electrolytic solution including an aqueous solvent. Related techniques of the lithium-ion secondary battery including the aqueous electrolytic solution have been considered in various ways.

In a secondary battery including a non-aqueous electrolyte, for example, a negative electrode that is a lithium titanate sintered body is used, and a mean fine pore diameter, a specific surface area, and a relative density related to the negative electrode are defined. In a secondary battery that includes an electrolyte layer including a non-aqueous electrolyte, for example, a negative electrode that is a sintered body of an oxide including lithium and a transition metal element is used, and a relative density of the negative electrode is defined.

In a secondary battery including a non-aqueous electrolyte, for example, a negative electrode that is a titanium-titanium oxide composite electrode is used, and the negative electrode includes titanium oxide of an anatase type having a nanotube shape. In a secondary battery including an aqueous electrolytic solution, for example, a negative electrode including titanium oxide is used.

### SUMMARY

The present application relates to a negative electrode for a lithium-ion secondary battery, and a lithium-ion secondary battery.

Although consideration has been given in various ways regarding related techniques of a lithium-ion secondary battery including an aqueous electrolytic solution, an operation characteristic of the lithium-ion secondary battery is not sufficient yet. Accordingly, there is still room for improvement in terms thereof.

It is therefore desirable to provide a negative electrode for a lithium-ion secondary battery, and a lithium-ion secondary battery that each make it possible to achieve a superior operation characteristic.

A negative electrode for a lithium-ion secondary battery according to an embodiment of the present technology allows a lithium ion to be inserted into and extracted from the negative electrode, and includes a negative electrode active material layer. The negative electrode active material layer includes negative electrode active material particles and has a porous structure in which the negative electrode active material particles are directly joined to each other. The negative electrode active material particles each include titanium oxide of an anatase type. An average particle size of the negative electrode active material particles is less than or equal to 100 nm.

A lithium-ion secondary battery according to an embodiment of the present technology includes a positive electrode which a lithium ion is to be inserted into and extracted from, a negative electrode, and an electrolytic solution including an aqueous solvent. The negative electrode has a configuration similar to the configuration of the negative electrode for a lithium-ion secondary battery according to the embodiment of the technology described above.

Here, the “average particle size of the negative electrode active material particles” is calculated based on an observation result (an electron micrograph) obtained by observing the negative electrode active material layer by means of an electron microscope. The definition of the “average particle size”, i.e., the procedure for calculating the average particle size based on the electron micrograph, will be described in detail later.

According to the negative electrode for a lithium-ion secondary battery or the lithium-ion secondary battery of an embodiment of the present technology, the negative electrode active material layer has the porous structure in which the negative electrode active material particles are directly joined to each other, the negative electrode active material particles each include titanium oxide of the anatase type, and the average particle size of the negative electrode active material particles is less than or equal to 100 nm. This makes it possible to achieve a superior operation characteristic.

Note that effects of the present technology are not necessarily limited to those described herein and may include any suitable effect, including described below, in relation to the present technology.

### BRIEF DESCRIPTION OF THE FIGURES

FIG. 1 is a sectional view of a configuration of a lithium-ion secondary battery according to an embodiment of the present technology.

FIG. 2 is an enlarged sectional view of a configuration of a negative electrode illustrated in FIG. 1.

FIG. 3 is a schematic diagram illustrating an electron micrograph of a section of a negative electrode active material layer illustrated in FIG. 2.

FIG. 4 is a sectional view of a configuration of a lithium-ion secondary battery according to an embodiment of the present technology.

FIG. 5 is a sectional view of a configuration of a lithium-ion secondary battery according to an embodiment.

FIG. 6 is a sectional view of a configuration of a lithium-ion secondary battery according to an embodiment.

FIG. 7 is a sectional view of a configuration of a lithium-ion secondary battery according to an embodiment.

### DETAILED DESCRIPTION

The present technology will described below in further detail including with reference to the drawings according to an embodiment.

A description is given first of a lithium-ion secondary battery according to an embodiment of the present technology.

Note that a negative electrode for a lithium-ion secondary battery (hereinafter, simply referred to as a “negative electrode”) according to an embodiment of the present technology is a part (a component) of the lithium-ion secondary battery, and is thus described below together.

The lithium-ion secondary battery to be described here is a secondary battery utilizing insertion and extraction of a lithium ion to allow charging and discharging reactions to proceed. The lithium-ion secondary battery includes a positive electrode, a negative electrode, and an aqueous electrolytic solution. The aqueous electrolytic solution is a liquid electrolyte. More specifically, the aqueous electrolytic solution is an electrolytic solution including an aqueous solvent, as described above.

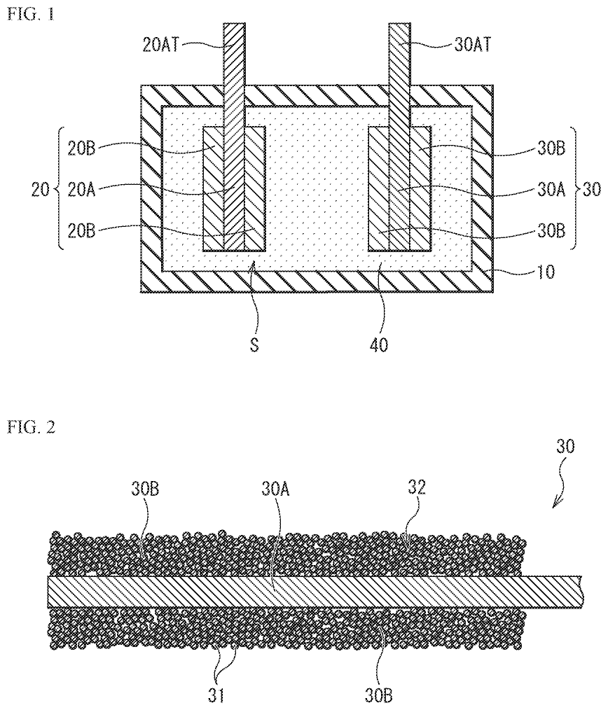

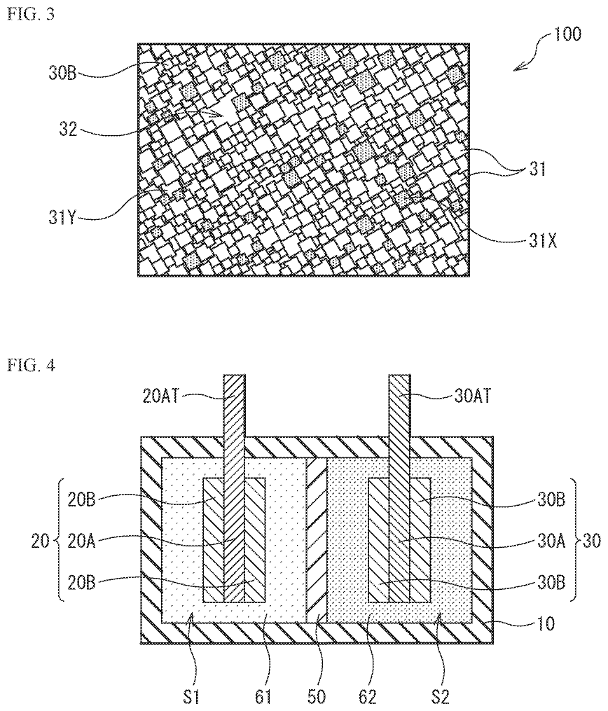

FIG. 1 illustrates a sectional configuration of the lithium-ion secondary battery according to an embodiment. FIG. 2 illustrates an enlarged sectional configuration of a negative electrode 30 illustrated in FIG. 1. FIG. 3 schematically illustrates an electron micrograph 100 of a section of a negative electrode active material layer 30B illustrated in FIG. 2.

As illustrated in FIGS. 1 and 2, the lithium-ion secondary battery includes an outer package body 10, a positive electrode 20, the negative electrode 30, and an electrolytic solution 40. In FIG. 1, the electrolytic solution 40 is lightly shaded.

As illustrated in FIG. 1, the outer package body 10 is a substantially box-shaped outer package member for containing components including, without limitation, the positive electrode 20, the negative electrode 30, and the electrolytic solution 40, and has an internal space S.

The outer package body 10 includes any one or more of materials including, without limitation, a metal material, a glass material, and a polymer compound. Note that the outer package body 10 may be, but not limited to, a rigid metal can, a rigid glass case, a rigid plastic case, a soft or flexible metal foil, or a soft or flexible polymer film.

As illustrated in FIG. 1, the positive electrode 20 is disposed in the internal space S, and allows the lithium ion to be inserted thereinto and extracted therefrom. Here, the positive electrode 20 includes a positive electrode current collector 20A having two opposed surfaces, and a positive electrode active material layer 20B provided on each of the two opposed surfaces of the positive electrode current collector 20A. However, the positive electrode active material layer 20B may be provided only on one of the two opposed surfaces of the positive electrode current collector 20A, on a side where the positive electrode 20 is opposed to the negative electrode 30.

Note that the positive electrode current collector 20A is omittable. That is, the positive electrode 20 may not include the positive electrode current collector 20A, and may thus include only the positive electrode active material layer 20B.

The positive electrode current collector 20A is an electrically conductive support member that supports the positive electrode active material layer 20B. The positive electrode current collector 20A includes any one or more of electrically conductive materials including, without limitation, a metal material, a carbon material, and an electrically conductive ceramic material. Specific examples of the metal material include titanium, aluminum, and an alloy of each thereof. Specific examples of the electrically conductive ceramic material include indium tin oxide (ITO).

In particular, the positive electrode current collector 20A preferably includes a material that is insoluble or sparingly soluble in and resistant to corrosion by the electrolytic solution 40, and that has low reactivity to a positive electrode active material to be described later. Therefore, the positive electrode current collector 20A preferably includes the above-described metal material. A reason for this is that degradation of the positive electrode current collector 20A is thereby suppressed even if the lithium-ion secondary battery is used.

Note that the positive electrode current collector 20A may be an electric conductor having a surface covered with plating of any of the above-described electrically conductive materials. The material included in the electric conductor is not particularly limited, and may thus be selected as desired.

Here, the positive electrode active material layer 20B is not provided on a portion of the positive electrode current collector 20A, i.e., a coupling terminal part 20AT, and the coupling terminal part 20AT is led from an inside (the internal space S) to an outside of the outer package body 10.

The positive electrode active material layer 20B includes any one or more of positive electrode active materials which the lithium ion is to be inserted into and extracted from. Note that the positive electrode active material layer 20B may further include any one or more of materials including, without limitation, a positive electrode binder and a positive electrode conductor.

The positive electrode active material includes, for example, a lithium-containing compound. The lithium-containing compound is a compound that includes lithium as a constituent element. The lithium-containing compound is not limited to a particular kind, and specific examples thereof include a lithium composite oxide and a lithium phosphoric acid compound. The lithium composite oxide is an oxide that includes lithium and one or more transition metal elements as constituent elements. The lithium phosphoric acid compound is a phosphoric acid compound that includes lithium and one or more transition metal elements as constituent elements. The transition metal elements are not limited to particular kinds, and specific examples thereof include nickel, cobalt, manganese, and iron.

Specific examples of the lithium composite oxide having a layered rock-salt crystal structure include LiNiO₂, LiCoO₂, LiCo_{0.98}Al_{0.01}Mg_{0.01}O₂, LiNi_{0.5}Co_{0.2}Mn_{0.3}O₂, LiNi_{0.8}Co_{0.15}Al_{0.05}O₂, LiNi_{0.33}Co_{0.33}Mn_{0.33}O₂, Li_{1.2}Mn_{0.52}Co_{0.175}Ni_{0.1}O₂, and Li_{1.15}(Mn_{0.65}Ni_{0.22}Co_{0.13})O₂. Specific examples of the lithium composite oxide having a spinel crystal structure include LiMn₂O₄. Specific examples of the lithium phosphoric acid compound having an olivine crystal structure include LiFePO₄, LiMnPO₄, LiMn_{0.5}Fe_{0.5}PO₄, LiMn_{0.7}Fe_{0.3}PO₄, and LiMn_{0.75}Fe_{0.25}PO₄.

The positive electrode binder includes any one or more of materials including, without limitation, a synthetic rubber and a polymer compound. Specific examples of the synthetic rubber include a styrene-butadiene-based rubber. Specific examples of the polymer compound include polyvinylidene difluoride and polyimide.

The positive electrode conductor includes any one or more of electrically conductive materials including, without limitation, a carbon material. Specific examples of the carbon material include graphite, carbon black, acetylene black, and Ketjen black. Note that the electrically conductive material may be a material such as a metal material, an electrically conductive ceramic material, or an electrically conductive polymer.

As illustrated in FIG. 1, the negative electrode 30 is disposed in the internal space S, and allows the lithium ion to be inserted thereinto and extracted therefrom. Here, the negative electrode 30 includes a negative electrode current collector 30A having two opposed surfaces, and the negative electrode active material layer 30B provided on each of the two opposed surfaces of the negative electrode current collector 30A. However, the negative electrode active material layer 30B may be provided only on one of the two opposed surfaces of the negative electrode current collector 30A on a side where the negative electrode 30 is opposed to the positive electrode 20.

Note that the negative electrode current collector 30A is omittable. That is, the negative electrode 30 may not include the negative electrode current collector 30A, and may thus include only the negative electrode active material layer 30B.

The negative electrode current collector 30A is an electrically conductive support member that supports the negative electrode active material layer 30B. The negative electrode current collector 30A includes any one or more of electrically conductive materials including, without limitation, a metal material, a carbon material, and an electrically conductive ceramic material. Specific examples of the metal material include stainless steel (SUS), titanium, tin, lead, and an alloy of each thereof. The stainless steel may be highly corrosion-resistant stainless steel that includes any one or more of additive elements including, without limitation, niobium and molybdenum added thereto. Specifically, the stainless steel may be, for example, SUS444 including molybdenum added thereto as an additive element. Details of the electrically conductive ceramic material are as described above.

In particular, the negative electrode current collector 30A preferably includes a material that is insoluble or sparingly soluble in and resistant to corrosion by the electrolytic solution 40, and that has low reactivity to a negative electrode active material to be described later. Therefore, the negative electrode current collector 30A preferably includes the above-described metal material. A reason for this is that degradation of the negative electrode current collector 30A is thereby suppressed even if the lithium-ion secondary battery is used.

Note that the negative electrode current collector 30A may be an electric conductor having a surface covered with plating of any of the above-described electrically conductive materials. The material included in the electric conductor is not particularly limited, and may thus be selected as desired.

Here, the negative electrode active material layer 30B is not provided on a portion of the negative electrode current collector 30A, i.e., a coupling terminal part 30AT, and the coupling terminal part 30AT is led from the inside (the internal space S) to the outside of the outer package body 10.

The negative electrode active material layer 30B includes a negative electrode active material which the lithium ion is to be inserted into and extracted from. Note that the negative electrode active material layer 30B may further include a material such as a negative electrode conductor. Details of the negative electrode conductor are similar to those of the positive electrode conductor.

As illustrated in FIG. 2, the negative electrode active material layer 30B includes the negative electrode active material in a form of particles (hereinafter, referred to as “negative electrode active material particles 31”). Each of the negative electrode active material particles 31 is what is called a primary particle.

The negative electrode active material layer 30B has a porous structure, and the porous structure includes the negative electrode active material particles 31 directly joined to each other. In other words, the negative electrode active material layer 30B has voids (fine pores 32) between the negative electrode active material particles 31, as a result of the negative electrode active material particles 31 being directly joined to each other. Thus, the negative electrode active material layer 30B has the porous structure including the negative electrode active material particles 31, as described above.

In detail, the negative electrode active material layer 30B is a sintered body of the negative electrode active material particles 31 formed by a firing method, and the negative electrode active material particles 31 are thus directly joined to each other inside the negative electrode active material layer 30B. A method of forming the negative electrode active material layer 30B by the firing method will be described in detail later.

The wording “directly joined to each other” means that the negative electrode active material layer 30B is the sintered body of the negative electrode active material particles 31, as described above. In other words, the negative electrode active material particles 31 are not indirectly coupled to each other via a binder, but are directly coupled to each other without the binder therebetween. Further, the negative electrode active material particles 31 are not indirectly coupled to each other via a conductor, thus not being electrically coupled to each other via the conductor. Instead, the negative electrode active material particles 31 are directly coupled to each other without the conductor therebetween, thus being electrically coupled to each other without the conductor therebetween.

A reason why the negative electrode active material layer 30B is the sintered body of the negative electrode active material particles 31 is that the negative electrode active material particles 31 are physically and electrically coupled to each other, which increases an energy density of the negative electrode active material layer 30B, and improves electron conductivity between the negative electrode active material particles 31. Thus, electric resistance decreases while the energy density is secured in the negative electrode 30, which makes it easier for the lithium-ion secondary battery to obtain a high discharge capacity.

Here, the negative electrode active material particles 31 each include titanium oxide having a crystal structure of an anatase type. A reason for this is that titanium oxide of the anatase type allows the charging and discharging reactions to easily proceed stably in the electrolytic solution 40 that is strongly alkaline to be described later, as compared with titanium oxide having a crystal structure of a rutile type or a brookite type. This makes it easier for the lithium-ion secondary battery to stably obtain a higher discharge capacity.

Further, an average particle size AS of the negative electrode active material particles 31 calculated based on an observation result of the section of the negative electrode active material layer 30B using an electron microscope is markedly small. Specifically, the average particle size AS is less than or equal to 100 nm. That is, each of the negative electrode active material particles 31 is what is called a nanoparticle. A reason for this is that this makes it easier for the lithium ion to move inside each of the negative electrode active material particles 31. Another reason is that this improves an energy density per weight of the negative electrode active material layer 30B, and makes it easier for the fine pores 32 serving as a movement path for the lithium ion to be formed inside the negative electrode active material layer 30B. This makes it easier for the lithium-ion secondary battery to obtain a further higher discharge capacity.

In particular, the average particle size AS is preferably less than or equal to 30 nm. A reason for this is that this makes it further easier for the lithium ion to move inside the negative electrode active material particle 31. Another reason is that this further improves the energy density per weight of the negative electrode active material layer 30B, and makes it further easier for the fine pores 32 to be formed inside the negative electrode active material layer 30B.

Note that a lower limit of the average particle size AS is not particularly limited. Specifically, the average particle size AS is greater than or equal to 7 nm. A reason for this is that this makes it easier for the negative electrode active material particles 31 to be formed stably.

Here, a procedure for calculating the average particle size AS is as described below. The electron micrograph 100 illustrated in FIG. 3 is used to calculate the average particle size AS.

Specifically, first, the secondary battery is disassembled to thereby collect the negative electrode 30. Thereafter, a surface of the negative electrode active material layer 30B is observed by means of the electron microscope to thereby obtain the electron micrograph 100. The electron microscope is not limited to a particular kind. Specifically, the electron microscope is any one or more of electron microscopes including, without limitation, a scanning electron microscope (SEM) and a transmission electron microscope (TEM). Observation conditions are set as follows: an acceleration voltage is set to 5.0 kV; and a magnification is set to 150,000 times.

In this case, the negative electrode 30 may be cut by means of, for example, an ion milling apparatus to thereby expose the section of the negative electrode active material layer 30B, following which the section of the negative electrode active material layer 30B may be observed to thereby obtain the electron micrograph 100. Usable as the ion milling apparatus is, for example, an ion milling apparatus, ArBlade (registered trademark) 5000, available from Hitachi High-Tech Corporation.

In the electron micrograph 100, as illustrated in FIG. 3, the porous structure having the fine pores 32 is observed because the negative electrode active material particles 31 are directly joined to each other. To simplify the illustration, FIG. 3 illustrates a case where each of the negative electrode active material particles 31 has a rectangular plan shape.

Thereafter, 50 negative electrode active material particles 31 are selected from the negative electrode active material particles 31 visually recognized in the electron micrograph 100, following which a particle size (a maximum outer size) of each of the negative electrode active material particles 31 is measured. As a result, 50 particle sizes S are obtained.

In the case of selecting the 50 negative electrode active material particles 31, the negative electrode active material particles 31 present in the very front among the negative electrode active material particles 31 overlapping with each other are selected. In other words, a negative electrode active material particle 31 (31Y) is not selected whose outer edge is not entirely visible because the negative electrode active material particle 31 and other one or more negative electrode active material particles 31 overlap with each other. In contrast, a negative electrode active material particle 31 (31X) is selected whose outer edge is entirely visible because the negative electrode active material particle 31 and other one or more negative electrode active material particles 31 do not overlap with each other. In FIG. 3, some negative electrode active material particles 31X to be selected are shaded.

Lastly, an average value of the 50 particle sizes S is calculated to thereby obtain the average value as the average particle size AS.

The negative electrode active material layer 30B is the sintered body of the negative electrode active material particles 31, as described above, and thus has characteristic configuration conditions resulting from the sintered body.

That is, the negative electrode active material layer 30B has a sufficiently large volume density, specifically, a volume density within a range from 1.0 g/cm³ to 3.5 g/cm³ both inclusive. Further, the negative electrode active material layer 30B has a sufficiently large specific surface area, specifically, a specific surface area within a range from 1 m²/g to 500 m²/g both inclusive, preferably within a range from 10 m²/g to 500 m²/g both inclusive. A reason for this is that this sufficiently increases the energy density and sufficiently reduces the electric resistance in the negative electrode 30.

A procedure for measuring the specific surface area of the negative electrode active material layer 30B is as described below. First, the lithium-ion secondary battery is disassembled to thereby collect the negative electrode 30. Thereafter, the negative electrode 30 is washed with a washing solvent, following which the negative electrode 30 is sufficiently dried in a vacuum heating furnace. In this case, an aqueous solvent such as pure water is used as the solvent, and a heating temperature is set within a range from 60° C. to 100° C. both inclusive. Lastly, degassing is performed at 200° C. for 30 minutes, following which the specific surface area of the negative electrode active material layer 30B is measured by a BET method using nitrogen gas. Usable as a measurement apparatus is, for example, a fully automated specific surface area measurement apparatus, Macsorb (registered trademark), available from Mountech Co., Ltd.

Note that a void rate of the fine pores 32 is not particularly limited, and is specifically within a range from 10% to 75% both inclusive. The void rate is calculated based on the following calculation expression: void rate (%)=[1−(volume density of negative electrode active material layer 30B/true density of negative electrode active material layer 30B)]×100.

Note that the negative electrode active material layer 30B may further include any one or more of other negative electrode active materials which the lithium ion is to be inserted into and extracted from.

The other negative electrode active material is not limited to a particular kind, and specific examples thereof include titanium oxide of the rutile type, titanium oxide of the brookite type, a carbon material, and a metal-based material. The metal-based material is a material including, as one or more constituent elements, any one or more of metal elements and metalloid elements that are each able to form an alloy with lithium.

Note that, when the negative electrode active material layer 30B includes the other negative electrode active material, measures described below may be taken to calculate the average particle size AS.

The negative electrode active material layer 30B is analyzed by X-ray diffractometry (XRD) in a case of examining whether the negative electrode active material layer 30B includes titanium oxide of the rutile type or the brookite type as the other negative electrode active material. This makes it possible to check the presence or absence of titanium oxide of the rutile type or the brookite type based on a difference in the crystal structure.

When the negative electrode active material layer 30B includes the carbon material or the metal-based material as the other negative electrode active material, the negative electrode active material layer 30B is analyzed by energy-dispersive X-ray spectroscopy (EDX). In this case, it is possible to check the presence or absence or the location of the carbon material or the metal-based material by elemental mapping.

The electrolytic solution 40 is contained in the internal space S, and is an aqueous electrolytic solution as described above. In other words, the electrolytic solution 40 is a solution in which an ionizable ionic material is dissolved or dispersed in the aqueous solvent.

The lithium-ion secondary battery according to the first embodiment is a lithium-ion secondary battery of what is called a one-component type, because the lithium-ion secondary battery includes one aqueous electrolytic solution (i.e., the electrolytic solution 40).

The electrolytic solution 40 includes the aqueous solvent and any one or more of ionic materials that are ionizable in the aqueous solvent. More specifically, the electrolytic solution 40 included in the lithium-ion secondary battery includes the lithium ion that is to be inserted into and extracted from each of the positive electrode 20 and the negative electrode 30.

The aqueous solvent is not limited to a particular kind, and specific examples thereof include pure water. The ionic material is not limited to a particular kind, and specifically includes any one or more of materials including, without limitation, an acid, a base, and an electrolyte salt. Specific examples of the acid include carbonic acid, oxalic acid, nitric acid, sulfuric acid, hydrochloric acid, acetic acid, and citric acid.

The electrolyte salt is a salt including a cation and an anion. More specifically, the electrolyte salt includes any one or more of lithium salts. Specific examples of the lithium salt include lithium carbonate, lithium oxalate, lithium nitrate, lithium sulfate, lithium chloride, lithium acetate, lithium citrate, lithium hydroxide, and an imide salt. Examples of the imide salt include lithium bis(fluorosulfonyl)imide and lithium bis(trifluoromethane sulfonyl)imide.

In particular, it is preferable that the electrolytic solution 40 included in the lithium-ion secondary battery of the one-component type have a pH that is higher than or equal to 11, and therefore be strongly alkaline as described above. A reason for this is that this makes it easier for the lithium ion to move in the electrolytic solution 40, and thus allows the charging and discharging reactions to proceed easily.

Accordingly, the electrolyte salt is preferably a material such as lithium hydroxide in particular. A reason for this is that this makes it easier to make the pH of the electrolytic solution 40 to be higher than or equal to 11, and to easily and stably achieve the electrolytic solution 40 that is strongly alkaline.

A content of the ionic material, i.e., a concentration (mol/kg) of the electrolytic solution 40, is not particularly limited, and may thus be set as desired. Specifically, the concentration of the electrolytic solution 40 is preferably within a range from 0.2 mol/kg to 4 mol/kg both inclusive. A reason for this is that this easily and stably achieves the electrolytic solution 40 that is strongly alkaline.

Note that the electrolyte salt may further include any one or more of other metal salts in addition to the above-described lithium salt. The other metal salt is not limited to a particular kind, and specific examples thereof include an alkali metal salt (excluding the lithium salt), an alkaline earth metal salt, and a transition metal salt. Specific examples of the alkali metal salt include a sodium salt and a potassium salt. Specific examples of the alkaline earth metal salt include a calcium salt and a magnesium salt.

It is more preferable that the electrolytic solution 40 be a saturated solution of the electrolyte salt. A reason for this is that this facilitates stable insertion and extraction of the lithium ion upon charging and discharging, which makes it easier for the charging and discharging reactions to proceed stably.

In order to check whether the electrolytic solution 40 is the saturated solution of the electrolyte salt, the lithium-ion secondary battery may be disassembled, following which the internal space S may be visually observed to thereby check whether the electrolyte salt is deposited. In the case of observing the internal space S, observed are specifically, for example, a location in the electrolytic solution 40, a location on a surface of the positive electrode 20, and a location on an inner wall surface of the outer package body 10. If the electrolyte salt is deposited and the electrolytic solution 40, which is a liquid, and the deposited matter of the electrolyte salt, which is a solid, therefore coexist, it is conceivable that the electrolytic solution 40 is a saturated solution of the electrolyte salt. In order to examine a composition of the deposited matter, a surface analysis method such as X-ray photoelectron spectroscopy (XPS) is usable, or a composition analysis method such as inductively coupled plasma (ICP) optical emission spectroscopy is usable.

The lithium-ion secondary battery operates as described below.

Upon charging, when the lithium ion is extracted from the positive electrode 20, the extracted lithium ion moves through the electrolytic solution 40 to the negative electrode 30. Thus, the lithium ion is inserted into the negative electrode 30.

Upon discharging, when the lithium ion is extracted from the negative electrode 30, the extracted lithium ion moves through the electrolytic solution 40 to the positive electrode 20. Thus, the lithium ion is inserted into the positive electrode 20.

In a case of fabricating the lithium-ion secondary battery, the positive electrode 20 and the negative electrode 30 are each fabricated and the electrolytic solution 40 is prepared, following which the lithium-ion secondary battery is assembled, in accordance with an example procedure described below.

First, the positive electrode active material, the positive electrode binder, and the positive electrode conductor are mixed with each other to thereby obtain a mixture. Note that a composition of the mixture may be changed as desired. Thereafter, the positive electrode mixture is put into a solvent to thereby prepare a positive electrode mixture slurry in paste form. The solvent may be an aqueous solvent, or may be an organic solvent. Lastly, the positive electrode mixture slurry is applied on the two opposed surfaces of the positive electrode current collector 20A (excluding the coupling terminal part 20AT) to thereby form the positive electrode active material layers 20B. Thereafter, the positive electrode active material layers 20B may be compression-molded by means of, for example, a roll pressing machine. In this case, the positive electrode active material layers 20B may be heated. The positive electrode active material layers 20B may be compression-molded multiple times. Thus, the positive electrode 20 is fabricated.

First, the negative electrode active material and the negative electrode binder are mixed with each other to thereby obtain a mixture. Note that a composition of the mixture may be changed as desired. In this case, any one or more of additives may be added to the mixture. The additive is not limited to a particular kind, and specific examples thereof include a surface active agent and a sintering aid.

As the negative electrode active material, the negative electrode active material particles 31 including titanium oxide of the anatase type and having the average particle size AS of less than or equal to 100 nm are used, as described above. The negative electrode binder is not limited to a particular kind, as long as the negative electrode binder is any one or more of polymer compounds to be mixed with the negative electrode active material for the purpose of improving strength of a powder molded body to be described later. Specific examples of the polymer compound include polyethylene glycol, polyvinyl alcohol, and polyvinyl butyral. In particular, it is preferable that the negative electrode binder be a polymer compound to be decomposed and degreased at a temperature lower than or equal to a temperature at which titanium oxide of the anatase type is fired. Specific examples of the surface active agent include a stearic acid. Specific examples of the sintering aid include an oxide of boron and an oxide of silicon.

Thus, granulated powder including the negative electrode active material particles 31 and the negative electrode binder is obtained.

Thereafter, the granulated powder is press-molded together with the negative electrode current collector 30A. A condition such as a pressing pressure may be set as desired. Thus, the granulated powder including the negative electrode active material particles 31 is fixed on each of the two opposed surfaces of the negative electrode current collector 30A. As a result, the powder molded body is obtained.

Lastly, the powder molded body is fired in the atmosphere. Conditions including, without limitation, a firing temperature and a firing time may be set as desired depending on, for example, a composition of the powder molded body. In this case, the conditions are adjusted to allow the negative electrode active material particles 31 including titanium oxide of the anatase type to be directly joined to each other while maintaining the state of the primary particles. For example, a maximum temperature during firing is within a range from 500° C. to 1200° C. both inclusive. Note that the firing process may be performed in an oxygen atmosphere.

In the firing process, the negative electrode binder is degreased in accordance with firing. Thus, the negative electrode active material particles 31 are directly joined to each other, and the fine pores 32 are formed between the negative electrode active material particles 31. This fixes a joined body (the sintered body) of the negative electrode active material particles 31 on the surface of the negative electrode current collector 30A, and thus forms the negative electrode active material layer 30B having the porous structure. As a result, the negative electrode 30 is fabricated.

In the case of fabricating the negative electrode 30, adjusting the above-described conditions including, without limitation, the pressing pressure, the firing temperature, and the firing time as appropriate makes it possible to adjust the joined state of the negative electrode active material particles 31 or the primary particles, and to adjust the volume density and the specific surface area of the negative electrode active material layer 30B.

Note that, in the case of fabricating the negative electrode 30, the above-described method of firing the powder molded body including the negative electrode binder may not be used. The procedure for fabricating the negative electrode 30 may be changed as appropriate, as long as the negative electrode active material layer 30B is formed by directly joining the negative electrode active material particles 31 to each other by a firing process. Specifically, a powder molded body obtained by press-molding the negative electrode active material particles 31 without using a negative electrode binder may be fired. Alternatively, a dispersion liquid in which the negative electrode active material particles 31 are dispersed may be applied on the negative electrode current collector 30A, and the dispersion liquid may be dried, following which the negative electrode current collector 30A with the dispersion liquid applied thereon may be fired.

The ionic material is added to the aqueous solvent. The ionic material is thereby dispersed or dissolved in the aqueous solvent. As a result, the electrolytic solution 40 is prepared. In this case, adjusting conditions including, without limitation, a kind and a concentration (mol/kg) of the ionic material makes it possible to adjust the pH of the electrolytic solution 40.

First, the positive electrode 20 and the negative electrode 30 are placed into the internal space S of the outer package body 10. In this case, the coupling terminal parts 20AT and 30AT are each led from the inside (the internal space S) to the outside of the outer package body 10.

Thereafter, the electrolytic solution 40 is supplied into the internal space S through an unillustrated injection hole provided in the outer package body 10. Thereafter, the injection hole is sealed.

Thus, the electrolytic solution 40 is contained in the internal space S in which the positive electrode 20 and the negative electrode 30 are each disposed. As a result, the lithium-ion secondary battery of the one-component type including one aqueous electrolytic solution (i.e., the electrolytic solution 40) is completed.

According to the lithium-ion secondary battery of an embodiment, the negative electrode active material layer 30B of the negative electrode 30 includes the negative electrode active material particles 31, and the negative electrode active material layer 30B has the porous structure in which the negative electrode active material particles 31 are directly joined to each other. Further, the negative electrode active material particles 31 each include titanium oxide of the anatase type, and the average particle size AS of the negative electrode active material particles 31 is less than or equal to 100 nm.

In this case, a series of kinds of action described below is achieved in the negative electrode 30, as described above.

Firstly, because the negative electrode active material layer 30B is the sintered body of the negative electrode active material particles 31, the negative electrode active material particles 31 are physically and electrically coupled to each other. This increases the energy density of the negative electrode active material layer 30B, and improves the electron conductivity between the negative electrode active material particles 31. Thus, the electric resistance decreases while the energy density is secured.

Secondly, because the negative electrode active material particles 31 each include titanium oxide of the anatase type, the negative electrode active material particles 31 are stable with respect to the electrolytic solution 40 that is strongly alkaline. This makes it easier for the charging and discharging reactions to proceed stably even when the electrolytic solution 40 that is strongly alkaline is used.

Thirdly, the average particle size AS of the negative electrode active material particles 31 being less than or equal to 100 nm makes it easier for the lithium ion to move inside each of the negative electrode active material particles 31. Moreover, this improves the energy density per weight of the negative electrode active material layer 30B, and makes it easier for the fine pores 32 serving as the movement path for the lithium ion to be formed inside the negative electrode active material layer 30B.

Based upon the above, in the lithium-ion secondary battery of the one-component type including one aqueous electrolytic solution (i.e., the electrolytic solution 40), it is easier to stably obtain a high discharge capacity, which makes it possible to achieve a superior operation characteristic.

In particular, the average particle size AS may be less than or equal to 30 nm. This makes it further easier for the lithium ion to move inside the negative electrode active material particles 31, further improves the energy density per weight of the negative electrode active material layer 30B, and makes it further easier for the movement path for the lithium ion to be formed inside the negative electrode active material layer 30B. Accordingly, it is possible to achieve higher effects.

Further, the volume density of the negative electrode active material layer 30B may be within the range from 1.0 g/cm³ to 3.5 g/cm³ both inclusive, and the specific surface area of the negative electrode active material layer 30B may be within the range from 1 m²/g to 500 m²/g both inclusive. This sufficiently increases the energy density and sufficiently reduces the electric resistance in the negative electrode 30. Accordingly, it is possible to achieve higher effects.

Further, the electrolytic solution 40 may have the pH that is higher than or equal to 11. This makes it easier for the lithium ion to move in the electrolytic solution 40. This allows the charging and discharging reactions to proceed easily. Accordingly, it is possible to achieve higher effects.

In addition, according to the negative electrode 30, the negative electrode active material layer 30B (the negative electrode active material particles 31) has the above-described configuration. Accordingly, it is possible for the lithium-ion secondary battery including the negative electrode 30 to achieve a superior operation characteristic, for the reasons described above.

Next, a description is given of a lithium-ion secondary battery according to another embodiment of the present technology.

The lithium-ion secondary battery according to an embodiment is a lithium-ion secondary battery of a two-component type including two aqueous electrolytic solutions (i.e., a positive electrode electrolytic solution 61 and a negative electrode electrolytic solution 62), unlike the lithium-ion secondary battery according to the first embodiment, which is the lithium-ion secondary battery of the one-component type including one aqueous electrolytic solution (i.e., the electrolytic solution 40).

FIG. 4 illustrates a sectional configuration of the lithium-ion secondary battery according to the second embodiment, and corresponds to FIG. 1. The lithium-ion secondary battery according to the second embodiment to be described here has a configuration similar to the configuration (FIG. 1) of the lithium-ion secondary battery according to the first embodiment except for those described below.

As illustrated in FIG. 4, the lithium-ion secondary battery further includes a partition 50, and includes the positive electrode electrolytic solution 61 and the negative electrode electrolytic solution 62 in place of the electrolytic solution 40. In FIG. 4, the positive electrode electrolytic solution 61 is lightly shaded, and the negative electrode electrolytic solution 62 is darkly shaded.

The outer package body 10 has two spaces that are separated from each other by the partition 50. The two spaces are a positive electrode compartment S1 and a negative electrode compartment S2.

The partition 50 is disposed between the positive electrode 20 and the negative electrode 30, and divides the internal space S (see FIG. 1) into the positive electrode compartment S1 and the negative electrode compartment S2. Accordingly, the positive electrode 20 and the negative electrode 30 are separated from each other with the partition 50 interposed therebetween, and are opposed to each other with the partition 50 interposed therebetween.

The partition 50 does not allow an anion to pass therethrough and allows a substance such as the lithium ion (a cation) other than the anion, which is to be inserted into and extracted from each of the positive electrode 20 and the negative electrode 30, to pass therethrough, between the positive electrode compartment S1 and the negative electrode compartment S2. A reason for this is to prevent mixing of the positive electrode electrolytic solution 61 and the negative electrode electrolytic solution 62 with each other. That is, the partition 50 allows the lithium ion to pass therethrough from the positive electrode compartment S1 to the negative electrode compartment S2, and allows the lithium ion to pass therethrough from the negative electrode compartment S2 to the positive electrode compartment S1.

Specifically, the partition 50 includes an ion exchange membrane, a solid electrolyte membrane, or both. The ion exchange membrane is a porous film that allows the lithium ion to pass therethrough, i.e., a positive ion exchange membrane. The solid electrolyte membrane has a lithium-ion conductive property. A reason for this is that a property of the partition 50 allowing the lithium ion to pass therethrough is thereby improved.

In particular, it is more preferable that the partition 50 include the ion exchange membrane than the solid electrolyte membrane. A reason for this is that this makes it easier for each of the aqueous solvent in the positive electrode electrolytic solution 61 and the aqueous solvent in the negative electrode electrolytic solution 62 to permeate into the partition 50, which improves the lithium-ion conductive property inside the partition 50.

The positive electrode 20 is disposed inside the positive electrode compartment S1, and allows the lithium ion to be inserted thereinto and extracted therefrom. The negative electrode 30 is disposed inside the negative electrode compartment S2, and allows the lithium ion to be inserted thereinto and extracted therefrom.

The positive electrode electrolytic solution 61 and the negative electrode electrolytic solution 62 are each the aqueous electrolytic solution. The positive electrode electrolytic solution 61 is contained inside the positive electrode compartment S1, and the negative electrode electrolytic solution 62 is contained inside the negative electrode compartment S2. The positive electrode electrolytic solution 61 and the negative electrode electrolytic solution 62 are therefore so separated from each other with the partition 50 interposed therebetween as not to be mixed with each other.

Thus, the positive electrode electrolytic solution 61 contained inside the positive electrode compartment S1 is in contact with only the positive electrode 20 and not in contact with the negative electrode 30. In contrast, the negative electrode electrolytic solution 62 contained inside the negative electrode compartment S2 is in contact with only the negative electrode 30 and not in contact with the positive electrode 20.

A pH of the positive electrode electrolytic solution 61 and a pH of the negative electrode electrolytic solution 62 are different from each other. Specifically, the pH of the negative electrode electrolytic solution 62 is higher than the pH of the positive electrode electrolytic solution 61. As long as such a high-and-low relationship related to the pH is satisfied, a composition (e.g., a kind of the aqueous solvent and a kind and a concentration of the ionic material) of each of the positive electrode electrolytic solution 61 and the negative electrode electrolytic solution 62 may be set as desired.

A reason why the pH of the negative electrode electrolytic solution 62 is higher than the pH of the positive electrode electrolytic solution 61 is that a decomposition potential of the aqueous solvent shifts owing to the pH difference. This widens a potential window of the aqueous solvent while thermodynamically suppressing a decomposition reaction of the aqueous solvent upon charging and discharging. Accordingly, it is easier for the charging and discharging reactions utilizing insertion and extraction of the lithium ion to proceed sufficiently and stably while a high voltage is obtained.

In particular, it is preferable that a composition formula (i.e., a kind of the electrolyte salt) of the positive electrode electrolytic solution 61 and a composition formula (i.e., a kind of the electrolyte salt) of the negative electrode electrolytic solution 62 be different from each other. A reason for this is that this makes it easier to secure the above-described high-and-low relationship related to the pH.

As long as the above-described high-and-low relationship related to the pH is satisfied, the value of the pH of each of the positive electrode electrolytic solution 61 and the negative electrode electrolytic solution 62 is not particularly limited.

In particular, the negative electrode electrolytic solution 62 that is in contact with the negative electrode 30 preferably has the pH that is higher than or equal to 11. The pH of the negative electrode electrolytic solution 62 is more preferably higher than or equal to 12, and still more preferably higher than or equal to 13. A reason for this is that this allows the negative electrode electrolytic solution 62 to have a sufficiently high pH, therefore making it further easier to secure the high-and-low relationship related to the pH. Another reason is that this provides a sufficiently large difference between the pH of the positive electrode electrolytic solution 61 and the pH of the negative electrode electrolytic solution 62, therefore making it easier to maintain the high-and-low relationship between the pHs of the two electrolytic solutions.

The positive electrode electrolytic solution 61 that is in contact with the positive electrode 20 preferably has the pH that is lower than 11. Specifically, the pH of the positive electrode electrolytic solution 61 is preferably within a range from 3 to 8 both inclusive, more preferably within a range from 4 to 8 both inclusive, and still more preferably within a range from 4 to 6 both inclusive. A reason for this is that this allows the positive electrode electrolytic solution 61 to have a sufficiently low pH, therefore making it further easier to secure the high-and-low relationship related to the pH, and making it easier to maintain the high-and-low relationship between the pHs of the two electrolytic solutions. Another reason is that this suppresses corrosion of, for example, the outer package body 10, the positive electrode current collector 20A, and the negative electrode current collector 30A, therefore improving electrochemical durability or stability of the lithium-ion secondary battery.

Note that the positive electrode electrolytic solution 61, the negative electrode electrolytic solution 62, or each of the positive electrode electrolytic solution 61 and the negative electrode electrolytic solution 62 is preferably a saturated solution of the electrolyte salt (the lithium salt), as with the electrolytic solution 40 according to the first embodiment. A reason for this is that this makes it easier for the charging and discharging reactions to proceed stably upon charging and discharging. A method of checking whether the positive electrode electrolytic solution 61 and the negative electrode electrolytic solution 62 are each the saturated solution of the lithium salt is similar to the method of checking whether the electrolytic solution 40 is the saturated solution of the lithium salt.

Further, the positive electrode electrolytic solution 61 and the negative electrode electrolytic solution 62 may each be a pH buffer solution. The pH buffer solution may be an aqueous solution in which a weak acid and a conjugate base thereof are mixed together, or an aqueous solution in which a weak base and a conjugate acid thereof are mixed together. A reason for this is that this sufficiently suppresses variation in pH, and therefore makes it easier to maintain each of the pH of the positive electrode electrolytic solution and the pH of the negative electrode electrolytic solution 62.

In particular, the positive electrode electrolytic solution 61 preferably includes, as one or more anions, any one or more of ions including, without limitation, a sulfuric acid ion, a hydrogen sulfuric acid ion, a carbonic acid ion, a hydrogen carbonic acid ion, a phosphoric acid ion, a monohydrogen phosphoric acid ion, a dihydrogen phosphoric acid ion, and a carboxylic acid ion. A reason for this is that this sufficiently suppresses variation in pH of the positive electrode electrolytic solution 61, therefore making it easier to sufficiently maintain the pH of the positive electrode electrolytic solution 61. Examples of the carboxylic acid ion include a formic acid ion, an acetic acid ion, a propionic acid ion, a tartaric acid ion, and a citric acid ion.

Note that the pH of the positive electrode electrolytic solution 61 and the pH of the negative electrode electrolytic solution 62 may each include any one or more of materials including, without limitation, tris(hydroxymethyl)aminomethane and ethylenediaminetetraacetic acid as one or more buffers.

More specifically, it is preferable that the positive electrode electrolytic solution 61 include any one or more of a sulfuric acid ion, a hydrogen sulfuric acid ion, a carbonic acid ion, a hydrogen carbonic acid ion, a phosphoric acid ion, a monohydrogen phosphoric acid ion, or a dihydrogen phosphoric acid ion as one or more anions, and the negative electrode electrolytic solution 62 include a hydroxide ion as an anion. A reason for this is that this makes it easier to control the pH of the positive electrode electrolytic solution 61 to be sufficiently low and to control the pH of the negative electrode electrolytic solution 62 to be sufficiently high.

Here, the positive electrode electrolytic solution 61 and the negative electrode electrolytic solution 62 are preferably isotonic solutions that are isotonic with each other. A reason for this is that this makes osmotic pressure of each of the positive electrode electrolytic solution 61 and the negative electrode electrolytic solution 62 appropriate, and therefore makes it easier to maintain the high-and-low relationship between the pHs of the two electrolytic solutions.

The lithium-ion secondary battery operates as described below.

Upon charging, when the lithium ion is extracted from the positive electrode 20, the extracted lithium ion moves through the positive electrode electrolytic solution 61, the partition 50, and the negative electrode electrolytic solution 62, to the negative electrode 30. Thus, the lithium ion is inserted into the negative electrode 30.

Upon discharging, when the lithium ion is extracted from the negative electrode 30, the extracted lithium ion moves through the negative electrode electrolytic solution 62, the partition 50, and the positive electrode electrolytic solution 61, to the positive electrode 20. Thus, the lithium ion is inserted into the positive electrode 20.

A procedure for manufacturing the lithium-ion secondary battery is similar to the above-described procedure for manufacturing the lithium-ion secondary battery according to an embodiment except for those described below.

In a case of preparing each of the positive electrode electrolytic solution 61 and the negative electrode electrolytic solution 62, the ionic material is added to the aqueous solvent. In this case, conditions including, without limitation, the kind and the concentration (mol/kg) of the ionic material are adjusted to thereby set the pH of the negative electrode electrolytic solution 62 to be higher than the pH of the positive electrode electrolytic solution 61.

In a case of assembling the lithium-ion secondary battery, first, the outer package body 10 to which the partition 50 is attached in advance is prepared. The outer package body 10 has the positive electrode compartment S1 and the negative electrode compartment S2. Thereafter, the positive electrode 20 is placed inside the positive electrode compartment S1, and the coupling terminal part 20AT is led from an inside to an outside of the positive electrode compartment S1. Further, the negative electrode 30 is placed inside the negative electrode compartment S2, and the coupling terminal part 30AT is led from an inside to an outside of the negative electrode compartment S2. Lastly, the positive electrode electrolytic solution 61 is supplied into the positive electrode compartment S1 through an unillustrated positive electrode injection hole that is provided in the outer package body 10, and the negative electrode electrolytic solution 62 is supplied into the negative electrode compartment S2 through an unillustrated negative electrode injection hole that is provided in the outer package body 10. Thereafter, the positive electrode injection hole and the negative electrode injection hole are each sealed.

Thus, the positive electrode electrolytic solution 61 is contained inside the positive electrode compartment S1 in which the positive electrode 20 is disposed, and the negative electrode electrolytic solution 62 is contained inside the negative electrode compartment S2 in which the negative electrode 30 is disposed. As a result, the lithium-ion secondary battery of the two-component type including two aqueous electrolytic solutions (i.e., the positive electrode electrolytic solution 61 and the negative electrode electrolytic solution 62) is completed.

According to the lithium-ion secondary battery of an embodiment, the negative electrode active material layer 30B (the negative electrode active material particles 31) of the negative electrode 30 has the above-described configuration, and the pH of the negative electrode electrolytic solution 62 is higher than the pH of the positive electrode electrolytic solution 61. Accordingly, it is possible to achieve a superior operation characteristic for a reason similar to the reason described above regarding the lithium-ion secondary battery according to an embodiment.

In this case, in particular, two aqueous electrolytic solutions (i.e., the positive electrode electrolytic solution 61 and the negative electrode electrolytic solution 62) having different pHs from each other are used. Accordingly, it is easier for the charging and discharging reactions utilizing insertion and extraction of the lithium ion to proceed sufficiently and stably while a high voltage is obtained. This makes it possible to achieve a further superior operation characteristic.

Other action and effects related to the lithium-ion secondary battery according are similar to other action and effects related to the lithium-ion secondary battery described above according to an embodiment. Action and effects related to the negative electrode 30 are similar to the action and effects related to the negative electrode 30 described above according to an embodiment.

The configuration of the lithium-ion secondary battery is appropriately modifiable, including as described below, according to an embodiment. Any two or more of the following series of modifications may be combined with each other.

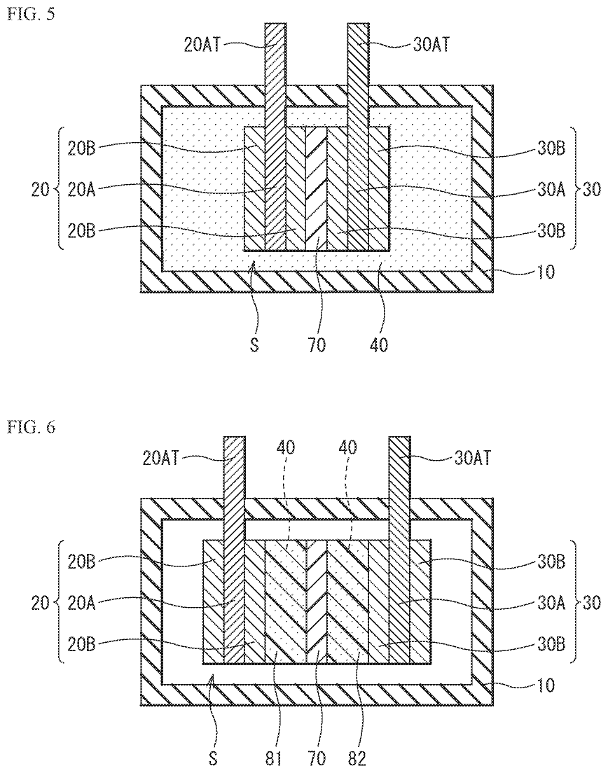

In an embodiment, the positive electrode 20 and the negative electrode 30 are separated from each other with the electrolytic solution 40 interposed therebetween. However, as illustrated in FIG. 5 corresponding to FIG. 1, the lithium-ion secondary battery may further include a separator 70, and the positive electrode 20 and the negative electrode 30 may thus be separated from each other with the separator 70 interposed therebetween. A configuration of the lithium-ion secondary battery illustrated in FIG. 5 is similar to that of the lithium-ion secondary battery illustrated in FIG. 1 except for those described below.

The separator 70 is disposed between the positive electrode 20 and the negative electrode 30, and is adjacent to each of the positive electrode 20 and the negative electrode 30. The separator 70 is an insulating porous film that allows a lithium ion to pass therethrough and separates the positive electrode 20 and the negative electrode 30 from each other. The separator 70 is impregnated with the electrolytic solution 40. A material included in the separator 70 is not particularly limited as long as the material is a porous insulating material.

For example, the separator 70 is a polymer compound film. The separator 70 includes any one or more of polymer compounds including, without limitation, polyolefin. Specific examples of the polymer compound include polyethylene and polypropylene.

Alternatively, the separator 70 is a solid electrolyte membrane. The solid electrolyte membrane is what is called an inorganic particle film. The inorganic particle film includes inorganic particles, a binder, and a fibrous substance.

The inorganic particles are in a form of particles, and include any one or more of inorganic materials. The inorganic material is a compound including, as one or more constituent elements, any one or more of cations of metal elements including, without limitation, Mg, Al, Si, Ca, Sc, Ti, V, Cr, Mn, Fe, Co, Ni, Cu, Zn, Ga, Ge, Sr, Y, Zr, Nb, Mo, Ru, Rh, Pd, Ag, In, Ba, Hf, Ta, W, Re, Ir, Pt, and Au. Note that the inorganic material includes any one or more of materials including, without limitation, an oxide, a sulfide, a hydroxide, a carbonic acid salt, and a sulfuric acid salt.

In particular, the inorganic material is preferably an inorganic solid electrolyte having a superior alkali metal ion-conductive property and high water resistance. A reason for this is that this prevents hydrolysis from occurring easily inside the lithium-ion secondary battery. Specifically, the inorganic solid electrolyte having a superior alkali metal ion-conductive property has a NASICON structure. More specifically, the inorganic solid electrolyte having a superior alkali metal ion-conductive property is, for example, a lithium phosphate solid electrolyte represented by a general formula of LiM₂(PO₄)₃. Note that M is any one or more of metal elements including, without limitation, Ti, Ge, Sr, Zr, Sn, and Al. In particular, M preferably includes Al and any one or more of metal elements including Ge, Zr, and Ti.

Specific examples of the lithium phosphate solid electrolyte having the NASICON structure include LATP (Li₁₊ₓAlₓTi₂₋ₓ(PO₄)₃), Li₁₊ₓAlₓGe₂₋ₓ(PO₄)₃, and Li₁₊ₓAlₓZr₂₋ₓ(PO₄)₃. Note that x satisfies 0<x≤5, preferably 0.1≤x≤0.5. In particular, the lithium phosphate solid electrolyte is preferably LATP. A reason for this is that superior water resistance is obtained, which prevents hydrolysis from occurring easily inside the lithium-ion secondary battery.

Alternatively, the inorganic material is preferably an oxide-based solid electrolyte. Specific examples of the oxide-based solid electrolyte include amorphous LIPON (Li_{2.9}PO_{3.3}N_{0.46}) and LLZ (Li₇La₃Zr₂O₁₂) having a garnet structure.

Alternatively, the inorganic material is a material such as an oxide-based ceramic, a carbonic acid salt, a sulfuric acid salt, or a nitride-based ceramic. Specific examples of the oxide-based ceramic include alumina, silica, zirconia, yttria, magnesium oxide, calcium oxide, barium oxide, strontium oxide, and vanadium oxide. Specific examples of the carbonic acid salt include sodium carbonate, potassium carbonate, magnesium carbonate, calcium carbonate, barium carbonate, lanthanum carbonate, and cerium carbonate. Specific examples of the sulfuric acid salt include calcium sulfate, magnesium sulfate, aluminum sulfate, gypsum, and barium sulfate. Specific examples of the phosphoric acid salt include hydroxyapatite, zirconium phosphate, and titanium phosphate. Specific examples of the nitride-based ceramic include silicon nitride, titanium nitride, and boron nitride. In particular, materials including, without limitation, alumina, silica, and calcium oxide are preferably in a state of glass ceramic.

Note that, for example, shapes of the inorganic particles, an average particle size of the inorganic particles, and a content of the inorganic particles in the inorganic particle film are not particularly limited, and may thus be set as desired. However, because the inorganic particles are a main component in the inorganic particle film, the content of the inorganic particles in the inorganic particle film is preferably sufficiently large. A reason for this is that this densifies the separator 70 and improves hydrophobicity of the separator 70.

The binder includes any one or more of polymer compounds. The polymer compound is a compound in which monomers each including a hydrocarbon having a predetermined functional group are polymerized. The functional group includes any one or more of elements including, without limitation, O, S, N, and F as one or more constituent elements. Specific examples of the polymer compound include polyvinyl formal, polyvinyl alcohol, polyvinyl acetal, polyvinyl butyral, polymethyl methacrylate, and polytetrafluoroethylene.

Note that, for example, a molecular weight of the binder and a content of the binder in the inorganic particle film are not particularly limited, and may thus be set as desired.

The fibrous substance is in a form of fibers, and includes any one or more of fibrous materials. The fibrous material preferably includes any one or more of hydrophilic functional groups. Specific examples of the hydrophilic functional group include a hydroxyl group, a sulfone group, and a carboxyl group. Specific examples of the fibrous material include cellulose fibers, a polysaccharide, polyvinyl alcohol, polyacrylic acid, an anionic derivative of polystyrene, and a cationic derivative of polystyrene. Examples of the anionic derivative of polystyrene include polystyrene sulfonate. Examples of the cationic derivative of polystyrene include polystyrene trialkylbenzylammonium. In particular, the fibrous material is preferably cellulose fibers. Note that a specific example of the fibrous material may be a derivative of any of the series of specific examples described above, or a copolymer including two or more of the series of specific examples.

Because the fibrous substance includes the hydrophilic functional group as described above, the electrolytic solution 40 is easily taken in between two or more portions of the fibrous substance. Thus, the separator 70 swells easily when the separator 70 is impregnated with the electrolytic solution 40.

Note that, for example, an average fiber diameter of the fibrous substance and a content of the fibrous substance in the inorganic particle film are not particularly limited, and may thus be set as desired.

Here, the separator 70 may be a stacked body including the polymer compound film and the inorganic particle film that are stacked on each other. The respective numbers of the polymer compound film and the inorganic particle film to be stacked in this case are not particularly limited, and may thus be set as desired.

In a case of manufacturing the inorganic particle film, first, the inorganic particle, the binder, and the fibrous substance are put into a solvent such as an organic solvent to thereby prepare a slurry. Thereafter, the slurry is poured into a mold. Lastly, the slurry is dried to thereby volatilize the solvent, following which the mold is removed. Thus, the inorganic particle film including the inorganic particles, the binder, and the fibrous substance is completed.

In this case also, the lithium ion is movable between the positive electrode 20 and the negative electrode 30 via the separator 70. Accordingly, it is possible to achieve effects similar to those of the case illustrated in FIG. 1.

In an embodiment, the partition 50 may be the solid electrolyte membrane or the inorganic particle film described in Modification 1. Details of the inorganic particle film are as described above.

In this case also, the lithium ion is movable between the positive electrode 20 and the negative electrode 30 via the partition 50. Accordingly, it is possible to achieve effects similar to those of the case illustrated in FIG. 1.

In an embodiment, the electrolytic solution 40, which is a liquid electrolyte, is used as illustrated in FIG. 1. However, as illustrated in FIG. 6 corresponding to FIG. 1, electrolyte layers 81 and 82 may be used instead of the electrolytic solution 40. The electrolyte layers 81 and 82 are gel electrolytes. A configuration of a lithium-ion secondary battery illustrated in FIG. 6 is similar to the configuration of the lithium-ion secondary battery illustrated in FIG. 1 except for those described below.

Here, the lithium-ion secondary battery further includes the separator 70 and the electrolyte layers 81 and 82. The separator 70 is disposed between the positive electrode 20 and the negative electrode 30, as described above. The electrolyte layer 81 is disposed between the positive electrode 20 and the separator 70, and the electrolyte layer 82 is disposed between the negative electrode 30 and the separator 70. Thus, the electrolyte layer 81 is adjacent to each of the positive electrode 20 and the separator 70, and the electrolyte layer 82 is adjacent to each of the negative electrode 30 and the separator 70.

The electrolyte layers 81 and 82 each include the electrolytic solution 40 and a polymer compound, and the electrolytic solution 40 is held by the polymer compound. The polymer compound is not limited to a particular kind, and specifically includes any one or more of materials including, without limitation, polyvinylidene difluoride and polyethylene oxide. In FIG. 6, the electrolyte layers 81 and 82 are each lightly shaded.

Details of the separator 70 are as described above, except that the separator 70 is an insulating porous film that allows a lithium ion to pass therethrough and separates the electrolyte layers 81 and 82 from each other. Specifically, the separator 70 includes any one or more of polymer compounds including, without limitation, polyolefin. Specific examples of the polyolefin include polyethylene and polypropylene. Alternatively, the separator 70 may be the solid electrolyte membrane or the inorganic particle film described in Modification 1. Details of the inorganic particle film are as described above.

In a case of forming the electrolyte layer 81, the electrolytic solution 40, the polymer compound, and a solvent for dilution are mixed with each other to thereby prepare a precursor solution in a sol form, following which the precursor solution is applied on the surface of the positive electrode 20. A procedure for forming the electrolyte layer 82 is similar to the procedure for forming the electrolyte layer 81 except that the precursor solution is applied on a surface of the negative electrode 30.

In this case also, the lithium ion is movable between the positive electrode 20 and the negative electrode 30 via the electrolyte layers 81 and 82. Accordingly, it is possible to achieve effects similar to those of the case illustrated in FIG. 1. In this case, it is possible to prevent leakage of the electrolytic solution in particular.

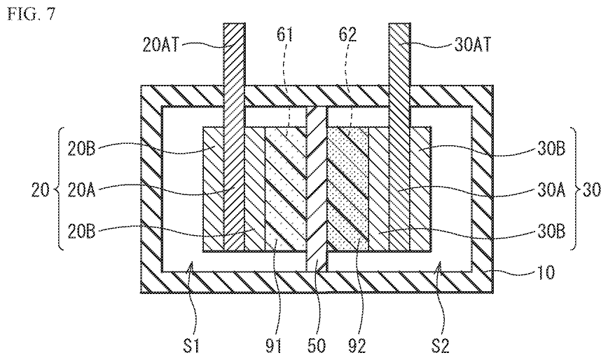

In an embodiment, the positive electrode electrolytic solution 61 and the negative electrode electrolytic solution 62, which are liquid electrolytes, are used as illustrated in FIG. 4. However, as illustrated in FIG. 7 corresponding to FIG. 4, electrolyte layers 91 and 92 may be used instead of the positive electrode electrolytic solution 61 and the negative electrode electrolytic solution 62. The electrolyte layers 91 and 92 are gel electrolytes. A configuration of a lithium-ion secondary battery illustrated in FIG. 7 is similar to the configuration of the lithium-ion secondary battery illustrated in FIG. 4 except for those described below.

Here, the lithium-ion secondary battery further includes the electrolyte layers 91 and 92. The electrolyte layer 91 is disposed between the positive electrode 20 and the partition 50, and the electrolyte layer 92 is disposed between the negative electrode 30 and the partition 50. Thus, the electrolyte layer 91 is adjacent to each of the positive electrode 20 and the partition 50, and the electrolyte layer 92 is adjacent to each of the negative electrode 30 and the partition 50.

The electrolyte layer 91 includes the positive electrode electrolytic solution 61 and a polymer compound, and the positive electrode electrolytic solution 61 is held by the polymer compound. The electrolyte layer 92 includes the negative electrode electrolytic solution 62 and a polymer compound, and the negative electrode electrolytic solution 62 is held by the polymer compound. Details of the kinds of the polymer compound are as described above. In FIG. 7, the electrolyte layer 91 including the positive electrode electrolytic solution 61 is lightly shaded, and the electrolyte layer 92 including the negative electrode electrolytic solution 62 is darkly shaded.

In a case of forming the electrolyte layer 91, the positive electrode electrolytic solution 61, the polymer compound, and a solvent for dilution are mixed with each other to thereby prepare a precursor solution in a sol form, following which the precursor solution is applied on the surface of the positive electrode 20. In a case of forming the electrolyte layer 92, the negative electrode electrolytic solution 62, the polymer compound, and a solvent for dilution are mixed with each other to thereby prepare a precursor solution in a sol form, following which the precursor solution is applied on the surface of the negative electrode 30.

Details of the configuration of the partition 50 are as described above. However, the partition 50 may be the solid electrolyte membrane or the inorganic particle film described in Modification 1. Details of the inorganic particle film are as described above.

In this case also, the lithium ion is movable between the positive electrode 20 and the negative electrode 30 via the electrolyte layers 91 and 92. Accordingly, it is possible to achieve effects similar to those of the case illustrated in FIG. 4. In this case, it is possible to prevent leakage of the electrolytic solution in particular.

Applications (application examples) of the lithium-ion secondary battery are not particularly limited. The lithium-ion secondary battery used as a power source may serve as a main power source or an auxiliary power source of, for example, electronic equipment and an electric vehicle. The main power source is preferentially used regardless of the presence of any other power source. The auxiliary power source is used in place of the main power source, or is switched from the main power source.

Specific examples of the applications of the lithium-ion secondary battery include: electronic equipment; apparatuses for data storage; electric power tools; battery packs to be mounted on, for example, electronic equipment; medical electronic equipment; electric vehicles; and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include home battery systems or industrial battery systems for accumulation of electric power for a situation such as emergency. The above-described applications may each use one lithium-ion secondary battery, or may each use multiple lithium-ion secondary batteries.

The battery pack may include a single battery, or may include an assembled battery. The electric vehicle is a vehicle that operates (travels) using the lithium-ion secondary battery as a driving power source, and may be a hybrid automobile that is additionally provided with a driving source other than the lithium-ion secondary battery. In an electric power storage system for home use, electric power accumulated in the lithium-ion secondary battery serving as an electric power storage source may be utilized for using, for example, home appliances.

Needless to say, the lithium-ion secondary battery may have applications other than the series of applications described here as examples.

### EXAMPLES

Examples of the present technology are described below according to an embodiment.

### Examples 1 to 11 and Comparative Examples 1 to 4

Electrochemical measurement cells were fabricated each using the negative electrode 30, following which the negative electrode 30 was evaluated for its characteristic.

### [Fabrication of Electrochemical Measurement Cell]

The electrochemical measurement cell having a configuration substantially similar to that of the lithium-ion secondary battery of the one-component type (FIG. 1) described in the first embodiment was fabricated in accordance with the following procedure.

### (Fabrication of Negative Electrode)

First, 100 parts by mass of the negative electrode active material (the negative electrode active material particles 31 including titanium oxide (TiO₂) of the anatase type), 10 parts by mass of the negative electrode binder (polyethylene glycol), and 1 part by mass of the additive (a surface active agent, Triton X (registered trademark), available from Nacalai Tesque, Inc.) were mixed with each other to thereby obtain the granulated powder. The average particle size AS (nm) of the negative electrode active material particles 31 was as listed in Table 1.

Thereafter, the negative electrode current collector 30A (a mesh-shaped titanium foil having a thickness of 200 μm) and the granulated powder were press-molded together by means of a pressing machine to thereby obtain the powder molded body.

Lastly, the powder molded body was fired at a firing temperature of 750° C. in the atmosphere. The negative electrode active material particles 31 were thereby directly joined to each other. Thus, the negative electrode active material layer 30B that was the sintered body of the negative electrode active material particles 31 was formed on each of the two opposed surfaces of the negative electrode current collector 30A. As a result, the negative electrode 30 was fabricated.

The volume density (g/cm³) and the specific surface area (m²/g) of the negative electrode active material layer 30B were as listed in Table 1. Note that, regarding the specific surface area, Table 1 lists only the specific surface areas related to the negative electrode active material layers 30B (Examples 1, 2, and 5 to 7 and Comparative example 1) of some of the series of the negative electrode active material layers 30B (Examples 1 to 11 and Comparative examples 1 to 4). In the case of fabricating the negative electrode 30, the pressing pressure described above was changed to thereby adjust the volume density of the negative electrode active material layer 30B.

For comparison, the negative electrode 30 was fabricated by a similar procedure except that titanium oxide of the rutile type was used instead of titanium oxide of the anatase type.

Further, for comparison, the negative electrode 30 was fabricated by a similar procedure except that a lithium-titanium composite oxide (Li₄Ti₅O₁₂ (LTO)) was used instead of titanium oxide of the anatase type.

### (Preparation of Electrolytic Solution)

The ionic material (the electrolyte salt) was put into the solvent (water that was the aqueous solvent), following which the solvent was stirred to thereby prepare the electrolytic solution 40 serving as the aqueous electrolytic solution. The kind of the electrolyte salt, the concentration (mol/kg) of the electrolytic solution 40, and the pH of the electrolytic solution 40 were as listed in Table 1. Used as the electrolyte salt were lithium hydroxide (LiOH), lithium carbonate (Li₂CO₃), and a mixture of lithium hydroxide and potassium hydroxide (KOH).

For comparison, an ionic material (lithium hexafluoride phosphate (LiPF₆) that was an electrolyte salt) was put into a solvent (ethylene carbonate (EC) and dimethyl carbonate (DMC) that were non-aqueous solvents or organic solvents), following which the solvent was stirred to thereby prepare a non-aqueous electrolytic solution as well. In this case, a mixture ratio (a weight ratio) between ethylene carbonate and dimethyl carbonate in the solvent was set to 50:50.

### (Assembly of Electrochemical Measurement Cell)

First, the positive electrode 20 and the negative electrode 30 were each placed in the internal space S of the outer package body 10 including glass (a glass beaker). In this case, a nickel metal foil was used as the positive electrode 20. Further, the coupling terminal parts 20AT and 30AT were each led from the inside to the outside of the outer package body 10. Thereafter, a reference electrode (an unillustrated silver-silver chloride electrode) was disposed in the internal space S. Lastly, the electrolytic solution 40 was supplied into the internal space S. Thus, the electrolytic solution 40 was contained in the internal space S. As a result, the electrochemical measurement cell was completed.

### [Characteristic Evaluation of Negative Electrode]

Evaluation of the operation characteristic (a discharge characteristic) of the negative electrode 30 revealed the results presented in Table 1.

In the case of evaluating the discharge characteristic, the electrochemical measurement cell was charged and discharged in an ambient temperature environment (at a temperature of 23° C.) to thereby calculate a discharge capacity (mAh/g) serving as an index for evaluating the discharge characteristic. The discharge capacity was a discharge capacity (mAh) per weight (g) of the negative electrode active material (the negative electrode active material particles 31).

Upon charging, the electrochemical measurement cell was charged with a constant current of 1 C until a voltage reached −1.45 V with respect to the reference electrode (silver-silver chloride), and was thereafter charged with a constant voltage of −1.45 V until a current reached 0.5 C. Upon discharging, the electrochemical measurement cell was discharged with a constant current of 1 C until the voltage reached −1.00 V with respect to the reference electrode described above. Note that 1 C was a value of a current that caused a battery capacity (a theoretical capacity) to be completely discharged in 1 hour, and 0.5 C was a value of a current that caused the battery capacity to be completely discharged in 2 hours.

TABLE 1

| | Negative electrode | | | | | | | | | |
|---|---|---|---|---|---|---|---|---|---|---|
| | | | | Negative electrode | | | | | | |
| | Negative electrode | | | active material layer | | | | | | |
| | active material particles | | | Volume | Specific | Electrolytic solution | | | | Discharge |
| | | Crystal | AS | density | surface area | | Electrolyte | Concentration | | capacity |
| | Kind | structure | (nm) | (g/cm³) | (m²/g) | Solvent | salt | (mol/kg) | pH | (mAh/g) |
| Example 1 | TiO₂ | Anatase type | 7 | 2.0 | 109 | Water | LiOH | 4 | 12 | 117 |
| Example 2 | TiO₂ | Anatase type | 9 | 2.1 | 62 | Water | LiOH | 4 | 12 | 109 |
| Example 3 | TiO₂ | Anatase type | 15 | 1.8 | — | Water | LiOH | | 12 | 98 |
| Example 4 | TiO₂ | Anatase type | 30 | 1.1 | — | Water | LiOH | 4 | 12 | 94 |
| Example 5 | TiO₂ | Anatase type | 30 | 1.7 | 38 | Water | LiOH | 4 | 12 | 93 |
| Example 6 | TiO₂ | Anatase type | 30 | 1.7 | 38 | Water | Li₂CO₃ | 0.2 | 10 | 50 |
| Example 7 | TiO₂ | Anatase type | 30 | 2.0 | 31 | Water | LiOH | 4 | 12 | 98 |
| Example 8 | TiO₂ | Anatase type | 30 | 2.8 | — | Water | LiOH | 4 | 12 | 97 |
| Example 9 | TiO₂ | Anatase type | 100 | 2.1 | — | Water | LiOH | 4 | 12 | 59 |
| Example 10 | TiO₂ | Anatase type | 30 | 1.5 | — | Water | KOH + LiOH | 6 + 1 | 14 | 95 |
| Example 11 | TiO₂ | Anatase type | 30 | 2.3 | — | Water | KOH + LiOH | 6 + 1 | 14 | 98 |
| Comparative example 1 | TiO₂ | Anatase type | 200 | 2.0 | 8 | Water | LiOH | 4 | 12 | 30 |
| Comparative example 2 | TiO₂ | Rutile type | 70 | 2.0 | — | Water | LiOH | 4 | 12 | 0 |
| Comparative example 3 | LTO | — | 50 | 1.8 | — | Water | LiOH | 4 | 12 | 41 |
| Comparative example 4 | TiO₂ | Anatase type | 30 | 2.0 | — | EC + DMC | LiPF₆ | 1 | — | Not calculable |

As indicated in Table 1, in the electrochemical measurement cell including the negative electrode 30 in which the negative electrode active material layer 30B was the sintered body of the negative electrode active material particles 31, the discharge capacity varied depending on, for example, the configuration of the negative electrode 30.

For example, in the electrochemical measurement cell including the aqueous electrolytic solution (i.e., the electrolytic solution 40), the discharge capacity was not obtained when titanium oxide of the rutile type was used as the material included in the negative electrode active material particles 31 (Comparative example 2), and the discharge capacity decreased when the lithium-titanium composite oxide (LTO) was used as the material included in the negative electrode active material particles 31 (Comparative example 3).

In the lithium-ion secondary battery including the non-aqueous electrolytic solution (Comparative example 4), it was not possible to perform discharging due to the fact that the above-described condition for terminating charging was reached quickly. As a result, the discharge capacity was not calculable.

In contrast, in the electrochemical measurement cell including the aqueous electrolytic solution (i.e., the electrolytic solution 40), when titanium oxide of the anatase type was used as the material included in the negative electrode active material particles 31 (Examples 1 to 11 and Comparative example 1), the discharge capacity varied greatly depending on the average particle size AS.

That is, the discharge capacity decreased when the average particle size AS was greater than 100 nm (Comparative example 1). However, the discharge capacity increased when the average particle size AS was less than or equal to 100 nm (Examples 1 to 11).

In particular, when the average particle size AS was less than or equal to 100 nm, the following tendencies were obtained. The discharge capacity further increased when the average particle size AS was less than or equal to 30 nm. A sufficient discharge capacity was obtained when the volume density of the negative electrode active material layer 30B was within the range from 1.0 g/cm³ to 3.5 g/cm³ both inclusive.

### Examples 12 and 13 and Comparative Example 5

Lithium-ion secondary batteries were fabricated each using the negative electrode 30, and the lithium-ion secondary batteries were evaluated for their respective characteristics.

### [Fabrication of Lithium-Ion Secondary Battery]

The lithium-ion secondary battery of the two-component type (FIG. 4) described in the second embodiment was fabricated in accordance with the following procedure.

### (Fabrication of Positive Electrode)

First, 91 parts by mass of the positive electrode active material (LiFePO₄ that was the lithium phosphoric acid compound), 3 parts by mass of the positive electrode binder (polyvinylidene difluoride), and 6 parts by mass of the positive electrode conductor (graphite) were mixed with each other to thereby obtain a positive electrode mixture. Thereafter, the positive electrode mixture was put into the solvent (N-methyl-2-pyrrolidone that was the organic solvent), following which the solvent was stirred to thereby prepare a positive electrode mixture slurry in paste form. Lastly, the positive electrode mixture slurry was applied on the two opposed surfaces of the positive electrode current collector 20A (a titanium foil having a thickness of 10 μm) excluding the coupling terminal part 20AT by means of a coating apparatus, following which the positive electrode mixture slurry was dried to thereby form the positive electrode active material layers 20B. Thus, the positive electrode 20 was fabricated.

### (Fabrication of Negative Electrode)

The negative electrode 30 was fabricated by the above-described procedure. Here, as listed in Table 2, fabricated were the two negative electrodes 30 (Examples 7 and 10) including titanium oxide of the anatase type as the material included in the negative electrode active material particles 31, and the negative electrode 30 (Comparative example 3) including the lithium-titanium composite oxide as the material included in the negative electrode active material particles 31.

### (Preparation of Positive Electrode Electrolytic Solution)

The ionic material (lithium sulfate (Li₂SO₄) that was the electrolyte salt) was put into the solvent (pure water that was the aqueous solvent), following which the solvent was stirred to thereby prepare the positive electrode electrolytic solution 61 serving as the aqueous electrolytic solution. The concentration (mol/kg) and the pH of the positive electrode electrolytic solution 61 were as listed in Table 2.

### (Preparation of Negative Electrode Electrolytic Solution)

The above-described electrolytic solution 40 was used as the negative electrode electrolytic solution 62. The concentration (mol/kg) and the pH of the negative electrode electrolytic solution 62 were as listed in Table 2.

### (Assembly of Lithium Ion Secondary Battery)

First, prepared as the outer package body 10 was a glass container with the partition 50 (a cation exchange membrane, Nafion 115 (registered trademark), available from Sigma-Aldrich Japan) attached to the inside thereof. Inside the outer package body 10, the positive electrode compartment S1 and the negative electrode compartment S2 were separated from each other with the partition 50 interposed therebetween in advance. Thereafter, the positive electrode 20 was placed inside the positive electrode compartment S1, following which the negative electrode 30 was placed inside the negative electrode compartment S2. In this case, the coupling terminal parts 20AT and 30AT were each led from the inside to the outside of the outer package body 10. Thereafter, the positive electrode electrolytic solution 61 was supplied into the positive electrode compartment S1, and the negative electrode electrolytic solution 62 was supplied into the negative electrode compartment S2. Thus, the positive electrode electrolytic solution 61 was contained inside the positive electrode compartment S1 and the negative electrode electrolytic solution 62 was contained inside the negative electrode compartment S2. As a result, the lithium-ion secondary battery of the two-component type was completed.

### [Characteristic Evaluation of Lithium-Ion Secondary Battery]

The operation characteristic (an initial charge and discharge characteristic and a cyclability characteristic) of the lithium-ion secondary battery was evaluated in accordance with the following procedure, which revealed the results presented in Table 2.

### (Initial Charge and Discharge Characteristic)

First, the lithium-ion secondary battery was charged in an ambient temperature environment (at a temperature of 23° C.) to thereby measure a charge capacity. When titanium oxide of the anatase type was used as the material included in the negative electrode active material particles 31, upon charging, the lithium-ion secondary battery was charged with a constant current of 2 C until a voltage reached 1.7 V. When the lithium-titanium composite oxide was used as the material included in the negative electrode active material particles 31, upon charging, the lithium-ion secondary battery was charged with a constant current of 2 C until a voltage reached 2.0 V. Note that 2 C was a value of a current that caused the battery capacity to be completely discharged in 0.5 hours.

Thereafter, the lithium-ion secondary battery was discharged in the same environment to thereby measure the discharge capacity. Upon discharging, the lithium-ion secondary battery was discharged with a constant current of 2 C until the voltage reached 1.2 V, regardless of the kind of the material included in the negative electrode active material particles 31.

Lastly, an initial charge and discharge efficiency serving as an index for evaluating the initial charge and discharge characteristic was calculated based on the following calculation expression: initial charge and discharge efficiency (%)=(discharge capacity/charge capacity)×100.

### (Cyclability Characteristic)

First, the lithium-ion secondary battery was charged and discharged in an ambient temperature environment (at a temperature of 23° C.) to thereby measure the discharge capacity (a first-cycle discharge capacity). Thereafter, the lithium-ion secondary battery was repeatedly charged and discharged in the same environment until the number of cycles reached 15 cycles to thereby measure the discharge capacity (a 15th-cycle discharge capacity). Charging and discharging conditions were similar to the charging and discharging conditions when the initial charge and discharge characteristic was examined. Lastly, a capacity retention rate serving as an index for evaluating the cyclability characteristic was calculated based on the following calculation expression: capacity retention rate (%)=(15th-cycle discharge capacity/first-cycle discharge capacity)×100.

TABLE 2

| | | | | | | | | | Initial | |
|---|---|---|---|---|---|---|---|---|---|---|
| | Negative electrode | | Positive electrode | | | Negative electrode | | | charge and | Capacity |
| | | Negative | electrolytic solution | | | electrolytic solution | | | discharge | retention |
| | | electrode active | Electrolyte | Concentration | | Electrolyte | Concentration | | efficiency | rate |
| | Configuration | material particles | salt | (mol/kg) | pH | salt | (mol/kg) | pH | (%) | (%) |
| Example 12 | Example 7 | TiO₂ | Li₂SO₄ | 2 | 5 | LiOH | 4 | 12 | 92 | 99 |
| | | (Anatase type) | | | | | | | | |
| Example 13 | Example 10 | TiO₂ | Li₂SO₄ | 2 | 5 | LiOH | 4 | 12 | 92 | 75 |
| | | (Anatase type) | | | | | | | | |
| Comparative | Comparative | LTO | Li₂SO₄ | 2 | 5 | LiOH | 4 | 12 | 36 | Not |
| example 5 | example 3 | | | | | | | | | calculable |

As indicated in Table 2, in the lithium-ion secondary battery that included two aqueous electrolytic solutions (i.e., the positive electrode electrolytic solution 61 and the negative electrode electrolytic solution 62) and the negative electrode 30 including the negative electrode active material layer 30B that was the sintered body of the negative electrode active material particles 31, the charge and discharge efficiency and the capacity retention rate each varied depending on the configuration of the negative electrode 30.

For example, when the lithium-titanium composite oxide was used as the material included in the negative electrode active material particles 31 (Comparative example 5), the charge and discharge efficiency decreased. In this case, it was not possible to repeatedly charge and discharge the lithium-ion secondary battery, and the capacity retention rate was thus not calculable.

In contrast, when titanium oxide of the anatase type was used as the material included in the negative electrode active material particles 31 (Examples 12 and 13), the charge and discharge efficiency markedly increased. In this case, it was possible to repeatedly charge and discharge the lithium-ion secondary battery, and a sufficient capacity retention rate was obtained as well, unlike the case where the lithium-titanium composite oxide was used.

Based upon the results presented in Tables 1 and 2, when: the negative electrode active material layer 30B of the negative electrode 30 included the negative electrode active material particles 31; the negative electrode active material layer 30B had the porous structure in which the negative electrode active material particles 31 were directly joined to each other; the negative electrode active material particles 31 each included titanium oxide of the anatase type; and the average particle size AS of the negative electrode active material particles 31 was less than or equal to 100 nm, the discharge characteristic, the initial charge and discharge characteristic, and the cyclability characteristic were each improved in the lithium-ion secondary battery including the aqueous electrolytic solution. Accordingly, it was possible to achieve a superior operation characteristic.

Although the configuration of the lithium-ion secondary battery of the technology has been described above with reference to some embodiments and Examples, the configuration of the lithium-ion secondary battery of the technology is not limited to those described with reference to the embodiments and Examples above, and is therefore modifiable in a variety of ways.

The effects described herein are mere examples, and effects of the present technology are therefore not limited to those described herein. Accordingly, the present technology may achieve any other suitable effect.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A lithium-ion secondary battery comprising:
a positive electrode which a lithium ion is to be inserted into and extracted from;
a negative electrode which the lithium ion is to be inserted into and extracted from, the negative electrode including a negative electrode active material layer; and
an electrolytic solution including an aqueous solvent, wherein
the negative electrode active material layer includes negative electrode active material particles and has a porous structure in which the negative electrode active material particles are directly joined to each other,
the negative electrode active material particles each include titanium oxide of an anatase type, and
an average particle size of the negative electrode active material particles is less than or equal to 100 nanometers.

2. The lithium-ion secondary battery according to claim 1, wherein the average particle size is less than or equal to 30 nanometers.

3. The lithium-ion secondary battery according to claim 1, wherein
a volume density of the negative electrode active material layer is greater than or equal to 1.0 grams per cubic centimeter and less than or equal to 3.5 grams per cubic centimeter, and
a specific surface area of the negative electrode active material layer is greater than or equal to 1 square meter per gram and less than or equal to 500 square meters per gram.

4. The lithium-ion secondary battery according to claim 1, wherein the electrolytic solution has a pH that is higher than or equal to 11.

5. The lithium-ion secondary battery according to claim 1, further comprising:
a positive electrode compartment inside which the positive electrode is disposed;
a negative electrode compartment inside which the negative electrode is disposed; and
a partition that is disposed between the positive electrode compartment and the negative electrode compartment and allows the lithium ion to pass through the partition, wherein
the electrolytic solution includes
a positive electrode electrolytic solution contained inside the positive electrode compartment, and
a negative electrode electrolytic solution contained inside the negative electrode compartment and having a pH higher than a pH of the positive electrode electrolytic solution.
